(19) United States
(12) Patent Application Publication
(10) Pub. No.: US 2009/0276306 A1
(43) Pub. Date: Nov. 5, 2009

(54) UTILIZING AN ELECTRONIC PAYMENT SYSTEM TO IMPLEMENT REBATE PROGRAMS

(76) Inventor: Herman Remon Hicks, Laveen, AZ (US)

Correspondence Address: SCHWEGMAN, LUNDBERG & WOESSNER/EBAY, P.O. BOX 2938, MINNEAPOLIS, MN, 55402, US

(21) Appl. No.: 12/112,566

(22) Filed: Apr. 30, 2008

(51) Int. Cl. G06Q 20/00; G06Q 30/00; G06F 15/16

(52) U.S. Cl. 705/14.17; 705/40; 705/14.34; 705/26; 709/206

(57) ABSTRACT

Some example embodiments described herein relate a system and method for utilizing an electronic payment system to implement rebate programs. The system includes a communication module that receives at an electronic payment system a request from a first party for making a rebate payment to a second party. The system further includes a processor that is connected to the communication module and a transaction module that deposits the rebate payment into an account of the second party that exists with the electronic payment system after receiving instruction from the processor. The method includes receiving a request at an electronic payment system for a first party to make a rebate payment to a second party and using the electronic payment system to make the rebate payment into an account of the second party that exists with the electronic payment system.

### TECHNICAL FIELD

Example embodiments relate generally to the technical field of electronic payment systems.

### BACKGROUND

The Internet and the World Wide Web (“Web”) have changed the landscape of information delivery and affected numerous aspects of life. One area that has benefited from this technological development is the ability for individuals to buy and sell products over the Internet (i.e., electronic commerce).

The resulting growth of electronic commerce has encouraged many different types of entities to be joined together in business relationships. These new relationships utilize a network of applications, servers and Websites which has created various technical challenges, especially with regard to payment for good and services. The challenges that electronic commerce created with regard to payment for good and services has lead to the formation of on-line payment systems that are often used as a convenient and efficient method of payment for goods and services.

The widespread use of the Internet has provided an efficient and low-cost platform for users to shop on-line from merchants all over the world and make payments for their purchases via on-line payment systems such as PAYPAL (a subsidiary of EBAY Inc. San Jose Calif.). PAYPAL allows a user to make payments for purchased items from the user's PAYPAL account, or other bank accounts that may be associated with the user that is linked to the PAYPAL account.

### BRIEF DESCRIPTION OF THE DRAWINGS

Some example embodiments are illustrated by way of example and not limitation in the figures of the accompanying drawings in which:

FIG. 1 is a diagram illustrating the functionality of an example system for utilizing an electronic payment system to implement rebate programs;

FIG. 2 is a block diagram illustrating an example embodiment of a system for utilizing an electronic payment system to implement rebate programs;

FIG. 3 is a flow diagram illustrating an example embodiment of a computerized method for utilizing an electronic payment system to implement rebate programs;

FIG. 4 is a flow diagram illustrating an example embodiment of a portion of the computerized method of FIG. 3;

FIG. 5 is a block diagram illustrating an example embodiment of a network-based payment system for utilizing an electronic payment system to implement rebate programs;

FIG. 6 shows an example set of applications that may be used by the network-based payment system of FIG. 5;

FIG. 7 is a block diagram illustrating a diagrammatic representation of a machine in the example form of a computer system; and

FIG. 8 is a screen shot illustrating an example embodiment of a page that may be prepared by the electronic payment system to be displayed to a user after receiving a rebate payment for the user from another party.

### DETAILED DESCRIPTION

Example methods and systems for utilizing an electronic payment system to implement rebate programs are described herein. In the following description, for purposes of explanation, numerous specific details are set forth to provide a thorough understanding of example embodiments. It will be evident, however, to one skilled in the art that the present invention may be practiced without these specific details.

Historically, one way to promote more traditional forms of commerce between buyers and sellers is through the use rebate offers. However, traditional rebate offers typically suffer from several drawbacks.

The process of obtaining a rebate from a manufacturer or purchaser is often cumbersome because the purchaser is typically required to fill out some type of form and then send it to a third party rebate processing center using a conventional postal service. The third party clearing rebate processing center then reviews the information by hand and then sends a check to the original purchaser using a conventional postal service.

The whole process typically takes several weeks for a rebate payment to be provided back to the purchaser and generates significant paperwork. According to Rebate Report Card at http://www.rebatereportcard.com/, most rebate experiences are negative.

Some example embodiments described herein may include a system for utilizing an electronic payment system to implement rebate programs. The system includes a communication module that receives at an electronic payment system a request from a first party for making a rebate payment to a second party. The system further includes a processor that is connected to the communication module and a transaction module that deposits the rebate payment into an account of the second party that exists with the electronic payment system after receiving instruction from the processor.

The system may allow electronic payment systems to facilitate additional use by customers of the electronic payment system. The increased usage of the electronic payment system would result because as customers build up a balance in their account by depositing rebate payments with the electronic payment system, these customers are more likely to use the electronic payment system.

In some embodiments, the communication module receives the request based on a response that is submitted by the second party to a rebate offer by the first party. The response to the rebate offer by the first party may be submitted by the second party via the communication module. In alternative embodiments, the response to the rebate offer that is made by the second party may be submitted directly to the first party via the Internet or using a postal service (e.g., US mail).

It should be noted that the first party may be a commercial entity such as a retailer or a manufacturer of the goods and services that pertain to the rebate offer. In addition, the commercial entity may be a rebate processing center that has a commercial relationship with a retailer, or a manufacturer of the goods and services which pertains to the rebate offer, so that the rebate processing center processes the rebate payments into the electronic payment system.

The system may allow rebate processing centers to benefit from a paperless way to deliver rebate payments to customers. In addition, the benefits of a paperless system may also extend to each party that is involved in the rebate payment process.

In some embodiments, the second party purchases goods or services to obtain the rebate offer. The goods or services may be purchased through a retailer or via the Internet (e.g., as part of an on-line auction). The system may also request and receive from the first and/or second party an instruction related to charging a transaction fee associated with using the electronic payment system to make the rebate payment.

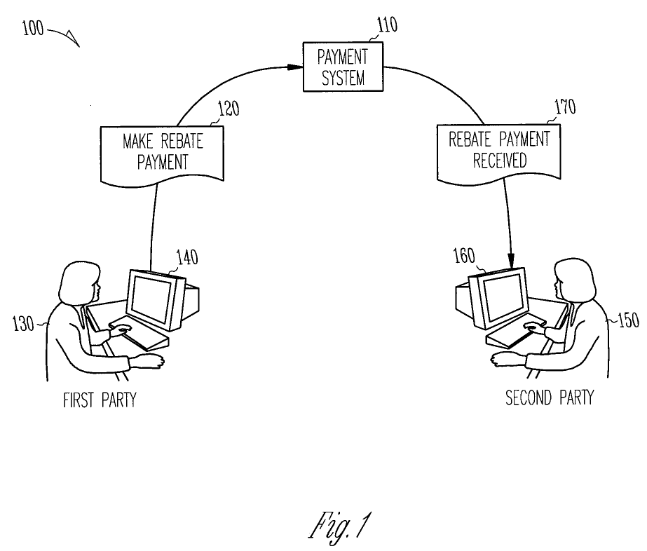

FIG. 1 is a diagram illustrating the functionality of an example a system 100 for utilizing an electronic payment system 110 to implement rebate programs. The electronic payment system 110 (e.g., PAYPAL or a financial institution such as a bank) may receive a request 120 from a first party 130 (e.g., a user at a first client machine 140) for making a rebate payment into an account of the second party 150 with the electronic payment system 110. The electronic payment system 110 may subsequently provide a notification 170 to the second party 150 (e.g., a user of a second client machine 160) once the rebate payment is received.

In some embodiments, the amount of the rebate payment may be withdrawn from an existing account that is associated with the first party 130 at the electronic payment system 110. The amount may also be withdrawn from a bank account that is associated with the first party 130 and linked to the electronic payment system 110. The first party 130 may also authorize the electronic payment system 110 to charge the amount to a credit or a debit card that is associated with the first party 130. The first party 130 may also send a personal check, money order, or other instruments to the electronic payment system 110 for the amount to be transmitted to the second party 150. Alternatively, the first party 130 may authorize the electronic payment system 110 to withdraw the amount from an account associated with the first party 130 (e.g., an account not linked to the payment system 110).

In some embodiments, the electronic payment system 110 may request from the first party 130 an instruction related to charging a transaction fee that is associated with the service of forwarding the rebate payment. The electronic payment system 110 may receive the instruction from the first party 130 or the second party 150.

As an example, an instruction from the first party 130 may be used to determine shares of the transaction fee that is to be charged to each of the first party 130 and the second party 150. The first party 130 may authorize the payment system 110 to charge the transaction fee, partially or entirely, to the first party 130. If the authorization is for partial charging, then the remainder of the transaction fee may be charged to the second party 150. The first party 130 may also instruct the payment system 110 to charge the entire transaction fee to the second party 150.

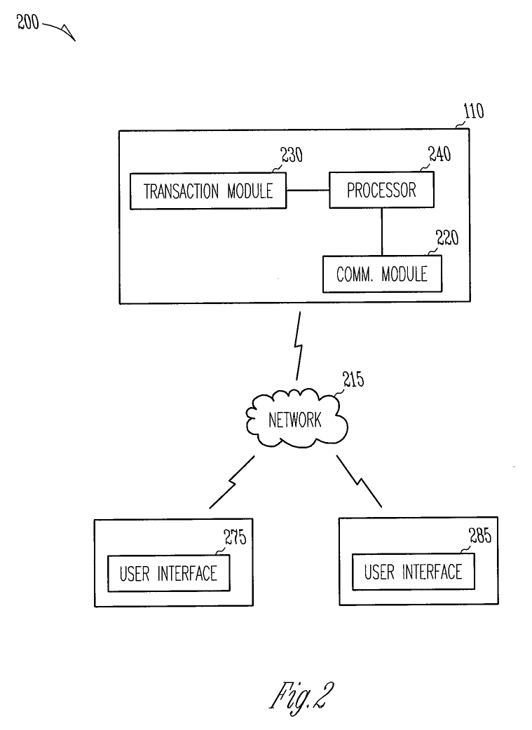

FIG. 2 is a block diagram illustrating an example embodiment of a system 200 for utilizing an electronic payment system 110 to implement rebate programs. The system 200 may include an electronic payment system 110, a first party client system 270 and a second party client system 280. In the illustrated example embodiment, the electronic payment system 110 includes a communication module 220, a transaction module 230 and a processor 240.

The communication module 220 may receive a request from a first party for making a rebate payment to a second party. The processor 240 is connected with the communication module 220 such that the processor 240 provides instruction to the transaction module 230 to deposit the rebate payment into an account of the second party that exists with the electronic payment system 110.

In some embodiments, the first party may utilize a user interface 275 to communicate with the electronic payment system 110 via a network 215. In addition, the second party may utilize a user interface 285 to receive notification that the rebate payment has been received. The notification may indicate the amount of the payment received from the first party as well as a name and/or an email address/telephone number of the first party.

Some example embodiments described herein relate to a computerized method for utilizing an electronic payment system to implement rebate programs. The method includes receiving a request at an electronic payment system for a first party to make a rebate payment to a second party and using the electronic payment system to make the rebate payment into an account of the second party that exists with the electronic payment system.

The computerized method may allow consumers to get their rebate payments faster. The improved processing time for obtaining rebate payments would enhance the overall purchasing experience of consumers and make consumers more likely to take advantage of other rebate offers.

Improving the overall rebate experience may make consumers more likely buy products from vendors who use rebates as an incentive. In addition, the information that is received by the vendors through the use of rebates may allow vendors (e.g. manufacturers and retailers) to market their products in a more efficient manner.

In some embodiments, receiving a request at an electronic payment system for a first party to make a rebate payment to a second party includes submitting a response by the second party to a rebate offer by the first party and generating the request at the electronic payment system based on the response submitted by the second party. As examples, submitting a response by the second party to a rebate offer by the first party may include submitting the response to the first party via (i) a postal service; (ii) the Internet; and/or (iii) the electronic payment system.

Submitting the response to the first party via the Internet and/or the electronic payment system may further enhance the overall experience with the rebate process for the second party (e.g., consumers). The desirability of using an electronic payment system may lead many consumers to increase purchases with vendors that utilize the electronic payment system as part of making rebate payments. In addition, vendors may be persuaded to provide incentives for using the electronic payment system based on the potential for increased sales and higher customer satisfaction.

In some embodiments, the first party may be a commercial entity such as a retailer or manufacturer while in other embodiments the first party may a rebate processing center that contracts with the retailer and/or manufacturer to process the rebate payments which need to be made to consumers. In addition, the second party may be an individual that purchases goods or services to obtain the rebate offer. It should be noted that the goods or services may be purchased over the Internet to obtain the rebate offer (e.g., as part of an on-line auction).

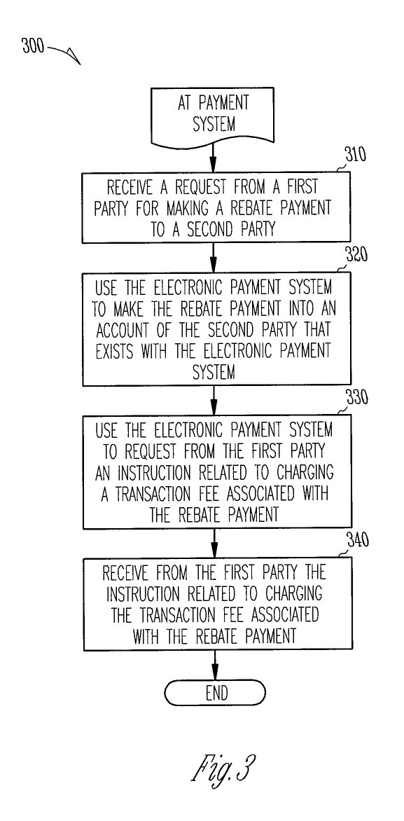

FIG. 3 is a flow diagram illustrating an example embodiment of a computerized method 300 for utilizing an electronic payment system 110 to implement rebate programs. The flow diagram of FIG. 3 describes the computerized method 300 from the point of view of the electronic payment system 110.

During operation 310, a communication module (e.g., communication module 220) may receive a request at an electronic payment system 110 for a first party to make a rebate payment to a second party. The electronic payment system 110 may at operation 320 use a transaction module (e.g., transaction module 240) to make the rebate payment into an account of the second party that exists with the electronic payment system 110.

In some embodiments, the computerized method 300 further includes (i) an operation 330 to use the electronic payment system 110 to request from the first party an instruction related to charging a transaction fee associated with the rebate payment; and (ii) an operation 340 to receive from the first party the instruction related to charging the transaction fee associated with the rebate payment.

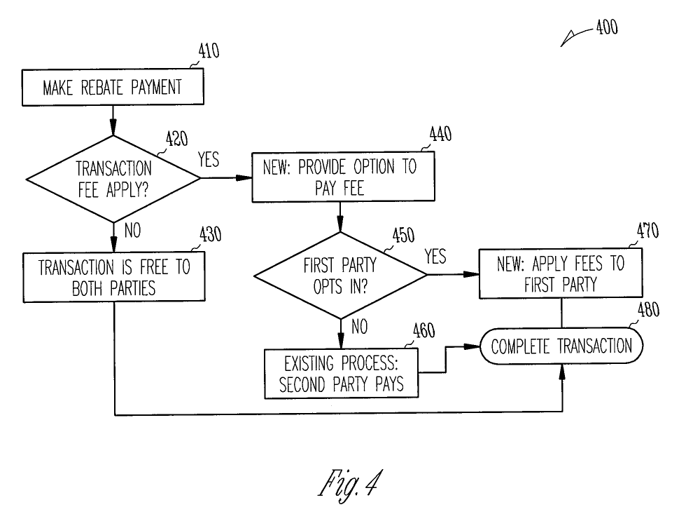

FIG. 4 is a flow diagram illustrating an example portion 400 of a computerized method (see, e.g., computerized method 300 of FIG. 3). During operation 410 the first party requests a rebate payment to be made by the electronic payment system 110 into an account of a second party for a particular amount. During operation 420 the electronic payment system 110 determines whether a transaction fee may be applied. If no transaction fee is be charged, a processor passes control to operation 430 where the first and/or second parties may be notified that no transaction fee was charged. The transaction then moves to completion at operation 480 where the total amount of the rebate payment that is paid by the first party is paid to the second party.

However, if the electronic payment system 110 decides at operation 440 that a transaction fee would be charged, the first party is provided with the option of paying the transaction fee or requesting that the second party pay the entire transaction fee or a portion of the fee. If the first party decides at operation 450 not to pay any portion of the transaction fee, the default operation 460 deducts the transaction fee from the rebate payment and control is passed to operation 480 where the electronic payment system 110 completes the transaction.

If the first party decides at operation 470 to pay all or part of the transaction fee, the electronic payment system 110 may apply the fee to the first party and/or second party and complete the transaction by charging the first party an appropriate portion of the transaction fee and deducting the remaining portion of the fee from the rebate payment that is paid to the second party.

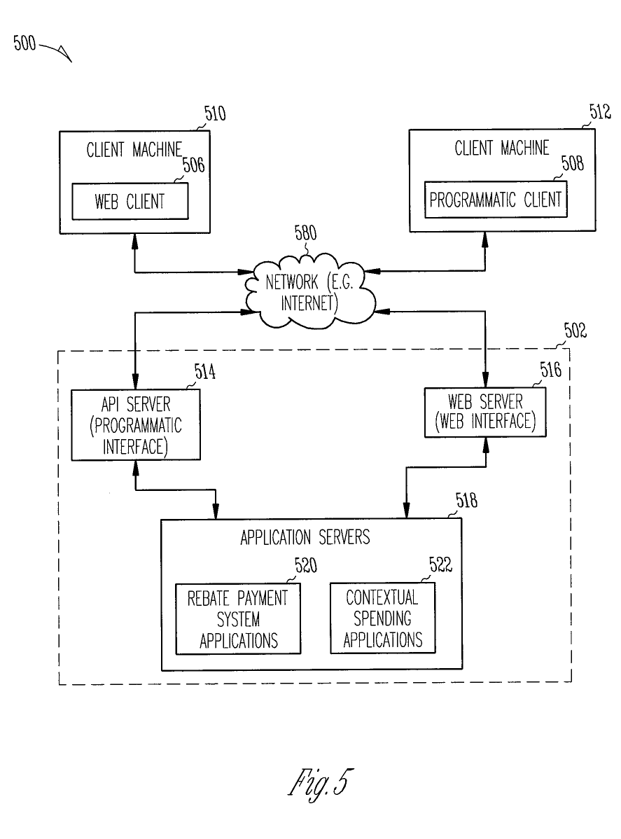

FIG. 5 is a block diagram illustrating an example embodiment of a network-based payment system 500 having a client-server architecture for utilizing an electronic payment system 502 to implement rebate programs. The network-based payment system 500 provides server-side functionality, via a network 580 (e.g., the Internet) to one or more clients. In the illustrated example embodiment, a Web client 506 (e.g., a browser, such as the INTERNET EXPLORER browser developed by MICROSOFT CORPORATION of Redmond, Wash.), and a programmatic client 508 are executed on respective client machines 510 and 512.

Turning to the electronic payment system 502, an Application Program Interface (API) server 514 and a Web server 516 are coupled to, and provide programmatic and Web interfaces respectively to, one or more application servers 518. The application servers 518 host one or more rebate payment system applications 520 and contextual spending applications 522. The rebate payment system applications 520 provide a number of rebate payment functions and services to users who access the electronic payment system 502. The contextual spending applications 522 may facilitate real-time contextual in person-to-person rebate payment activities over the network 580.

Further, while the network-based payment system 500 shown in FIG. 5 employs a client-server architecture, the present application is of course not limited to such an architecture and could equally well find application in a distributed, or peer-to-peer, architecture system. The various rebate payment system and contextual spending applications 520 and 522 may also be implemented as standalone software programs, which do not necessarily have networking capabilities.

It should be appreciated that the Web client 506 may access the various rebate payment system and contextual spending applications 520 and 522 via the Web interface supported by the Web server 516. Similarly, the programmatic client 508 may access the various rebate services and functions provided by the rebate payment system and contextual spending applications 520 and 522 via the programmatic interface provided by the API server 514. The programmatic client 508 may include registration applications to provide interested users (e.g., users of the network-based payment system) with registration forms to sign up for on-line rebate payments.

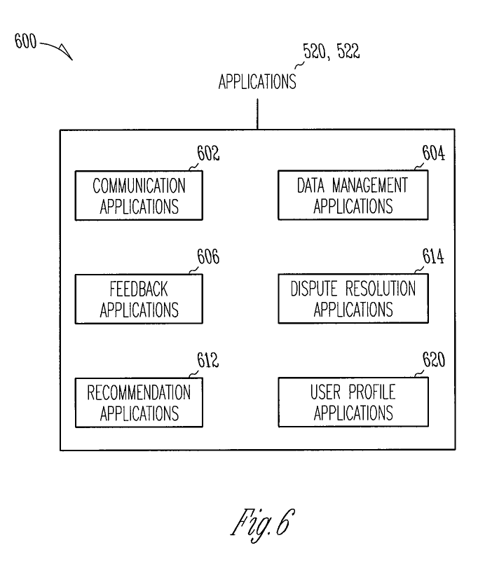

FIG. 6 shows an example set of applications 600 that may be included in the applications 520 and 522 on the application server 518 which is used by the network-based payment system of FIG. 5. The network-based payment system 500 may provide a number of on-line payment mechanisms which may facilitate a user paying an amount to another user that utilizes the network-based payment system 500.

The applications 520 and 522 may include one or more communication applications 602 that support various communications between the network-based payment system 500 and users of the network-based payment system 500. As an example, a first party may request a rebate payment into an account of a second party using the network-based payment system 500.

The applications 520 and 522 may further include various data management applications 604 that provide a number of features in support of actions such as making contextual recommendations. The data managed by the data management applications 604 may include user profile data such as a rebate payer transaction history.

A number of feedback applications 606 may allow the users of the network-based payment system 500 to evaluate services provided by the network-based payment system 500 relating to rebate payment procedures. This type of feedback may be effective in enhancing the rebate payment services that are provided by the network-based payment system 500 by causing modifications to the network-based payment system 500 based on feedback received from users.

Dispute resolution applications 614 may also provide mechanisms whereby disputes arising between transacting parties may be resolved. The dispute resolution applications 614 may provide guided procedures whereby the first and second parties are guided through a number of steps in an attempt to settle a dispute. In the event that the dispute cannot be settled via the guided procedures, the dispute may be escalated to a mediator or arbitrator.

Example Machine Architecture

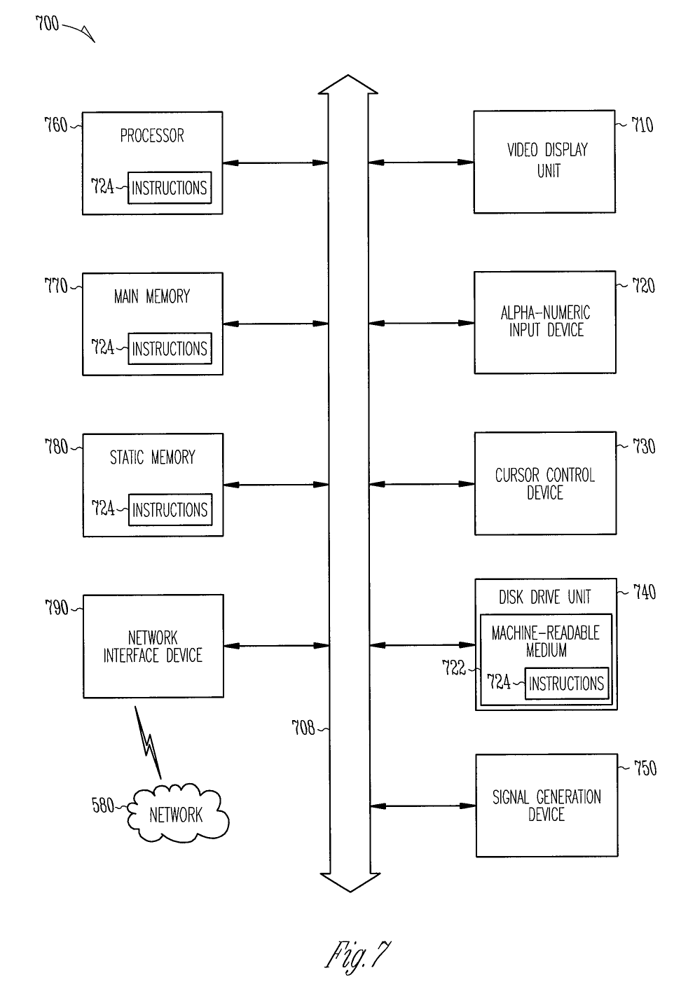

FIG. 7 is a block diagram that illustrates a diagrammatic representation of a machine 700 in the example form of a computer system within which a set of instructions for causing the machine to perform any one or more of the methodologies discussed herein may be executed. In alternative embodiments, the machine 700 may operate as a standalone device or may be connected (e.g., networked) to other machines. In a networked environment, the machine 700 may operate in the capacity of a server or a client machine in a server-client network environment, or as a peer machine in a peer-to-peer (or distributed) network environment.

The machine 700 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 760 (e.g., a central processing unit (CPU), a graphics processing unit (GPU) or both), a main memory 770 and a static memory 780, all of which communicate with each other via a bus 708. The computer system 700 may further include a video display unit 710 (e.g., liquid crystal displays (LCD) or cathode ray tube (CRT)). The computer system 700 also may include an alphanumeric input device 720 (e.g., a keyboard), a cursor control device 730 (e.g., a mouse), a disk drive unit 740, a signal generation device 750 (e.g., a speaker), and a network interface device 790.

The disk drive unit 740 may include a machine-readable medium 722 on which is stored one or more sets of instructions (e.g., software 724) embodying any one or more of the methodologies or functions described herein. The software 724 may also reside, completely or at least partially, within the main memory 770 and/or within the processor 760 during execution thereof by the computer system 700, the main memory 770 and the processor 760 also constituting machine-readable media. It should be noted that the software 724 may further be transmitted or received over a network (e.g., network 580 in FIG. 5) via the network interface device 790.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

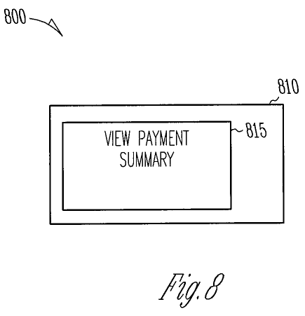

FIG. 8 is an example screen shot illustrating a page 800 that may be prepared by the electronic payment system 110 for display to a user (e.g., the second party) after receiving a rebate payment from another party (e.g., the first party). The page 800 may be shown to the user after the user logs into the electronic payment system 110. As an example, the user may log into the electronic payment system 110 after receiving an email or a text message from the electronic payment system 110 that the user has received a rebate payment.

In the illustrated example embodiment, the page 800 includes a view window 810 which has a View Payment Summary portion 815. The View Payment Summary portion 815 may display to the user a brief description of the amount of the payment; and/or an email/phone number that is associated with the rebate payer (among other items).

Thus, a computerized method and system for utilizing an electronic payment system to implement rebate programs is described herein. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computerized method comprising:
receiving a request at an electronic payment system for a first party to make a rebate payment to a second party; and
using the electronic payment system to make the rebate payment into an account of the second party that exists with the electronic payment system.

2. The computerized method of claim 1, wherein receiving a request at an electronic payment system for a first party to make a rebate payment to a second party includes submitting a response by the second party to a rebate offer by the first party and generating the request at the electronic payment system based on the response submitted by the second party.

3. The computerized method of claim 2, wherein submitting a response by the second party to a rebate offer by the first party includes submitting the response via a postal service.

4. The computerized method of claim 2, wherein submitting a response by the second party to a rebate offer by the first party includes submitting the response via the Internet directly to the first party.

5. The computerized method of claim 2, wherein submitting a response by the second party to a rebate offer by the first party includes submitting the response via the electronic payment system to the first party.

6. The computerized method of claim 2, wherein the first party is a commercial entity.

7. The computerized method of claim 6, wherein the commercial entity is a manufacturer.

8. The computerized method of claim 6, wherein the commercial entity is a retailer.

9. The computerized method of claim 6, wherein the commercial entity is a rebate processing center that is in a commercial relationship with a third party.

10. The computerized method of claim 9, wherein the third party is a manufacturer.

11. The computerized method of claim 6, wherein the second party is an individual.

12. The computerized method of claim 1, wherein the second party purchases goods or services to obtain the rebate offer.

13. The computerized method of claim 1, wherein the second party purchases goods or services over the Internet to obtain the rebate offer.

14. The computerized method of claim 13, wherein the second party purchases goods or services as part of an on-line auction.

15. The computerized method of claim 1, further comprising:
using the electronic payment system to request from the first party an instruction related to charging a transaction fee associated with the rebate payment; and
receiving from the first party the instruction related to charging the transaction fee associated with the rebate payment.

16. A system comprising:
a communication module that receives at an electronic payment system a request from a first party for making a rebate payment to a second party;
a processor connected with the communication module; and
a transaction module that sends the rebate payment to an account of the second party that exists with the electronic payment system after receiving instruction from the processor.

17. The system of claim 16, wherein the communication module receives the request based on a response that is submitted by the second party to a rebate offer by the first party.

18. The system of claim 17, wherein the response submitted by the second party to the rebate offer by the first party is done via a postal service.

19. The system of claim 17, wherein the response submitted by the second party to the rebate offer by the first party is done via the Internet directly to the first party.

20. The system of claim 17, wherein the response submitted by the second party to the rebate offer by the first party is done via the communication module.

21. The system of claim 16, wherein the first party is a commercial entity.

22. The system of claim 21, wherein the commercial entity is a manufacturer and the second party is an individual.

23. The system of claim 21, wherein the commercial entity is a rebate processing center that is in a commercial relationship with a manufacturer of goods or services that are the subject of the rebate offer.

24. The system of claim 16, wherein the second party purchases goods or services to obtain the rebate offer.

25. The system of claim 16, wherein the second party purchases goods or services via the Internet to obtain the rebate offer.

26. The system of claim 25, wherein the second party purchases goods or services via an on-line auction to obtain the rebate offer.

27. A machine-readable medium comprising instructions, which when implemented by one or more processors perform the following operations:
receiving a request at an electronic payment system for a first party to make a rebate payment to a second party; and
using the electronic payment system to make the rebate payment into an account of the second party that exists with the electronic payment system.

28. The machine-readable medium of claim 27 wherein receiving a request at an electronic payment system for a first party to make a rebate payment to a second party includes submitting a response by the second party to a rebate offer by the first party and generating the request at the electronic payment system based on the response to the rebate offer submitted by the second party.

29. The machine-readable medium of claim 28 further comprising instructions which when implemented by one or more processors further perform the following operation:
submitting the response to the rebate offer from the second party via the electronic payment system to the first party.

30. The machine-readable medium of claim 27 further comprising instructions which when implemented by one or more processors further perform the following operations:
using the electronic payment system to request from the first party an instruction related to charging a transaction fee associated with the rebate payment; and
receiving from the first party the instruction related to charging the transaction fee associated with the rebate payment.

31. The machine-readable medium of claim 27 further comprising instructions which when implemented by one or more processors further perform the following operations:
using the electronic payment system to request from the second party an instruction related to charging a transaction fee associated with the rebate payment; and
receiving from the second party the instruction related to charging the transaction fee associated with the rebate payment.
